(19) United States
(12) Patent Application Publication
(10) Pub. No.: US 2023/0401454 A1
(43) Pub. Date: Dec. 14, 2023

(54) METHOD USING WEIGHTED AGGREGATED ENSEMBLE MODEL FOR ENERGY DEMAND MANAGEMENT OF BUILDINGS

(71) Applicants: Nikhil Pachauri, Manipal (IN); Chang Wook Ahn, Buk-gu (KR); Saurabh Agarwal, Greater Noida (IN); Tushar Bhardwaj, Miami, FL (US); Gaurav Mishra, Mississauga (CA); Kumar Shubham, Greater Noida (IN); Manoj Kumar Tiwari, Delhi (IN); Yagyadatta Goswami, Delhi (IN)

(72) Inventors: Nikhil Pachauri, Manipal (IN); Chang Wook Ahn, Buk-gu (KR); Saurabh Agarwal, Greater Noida (IN); Tushar Bhardwaj, Miami, FL (US); Gaurav Mishra, Mississauga (CA); Kumar Shubham, Greater Noida (IN); Manoj Kumar Tiwari, Delhi (IN); Yagyadatta Goswami, Delhi (IN)

(21) Appl. No.: 18/164,505

(22) Filed: Feb. 3, 2023

(51) Int. Cl. G06N 5/02; G05B 15/02

(52) U.S. Cl. CPC G06N 5/02; G05B 15/02

(57) ABSTRACT

A method using weighted aggregated ensemble model for energy demand management of buildings includes initializing data values for integrated model to measure energy consumption, perform statistical analysis on data values to estimate accurate prediction, optimizing the data values using marine predator optimization for integrated model, analyze the output to minimize the mean square error and results show improvement in accuracy of integrated model. The data values comprise of σ, maximum number of splits, minimum leaf size, and λ. The weighted aggregated ensemble model for energy demand management of buildings shows best performance compared with other predictive models such as linear regression (LR), support vector regression (SVR), multilayer perceptron neural network (MLPNN), decision tree (DT), and generalized additive model (GAM).

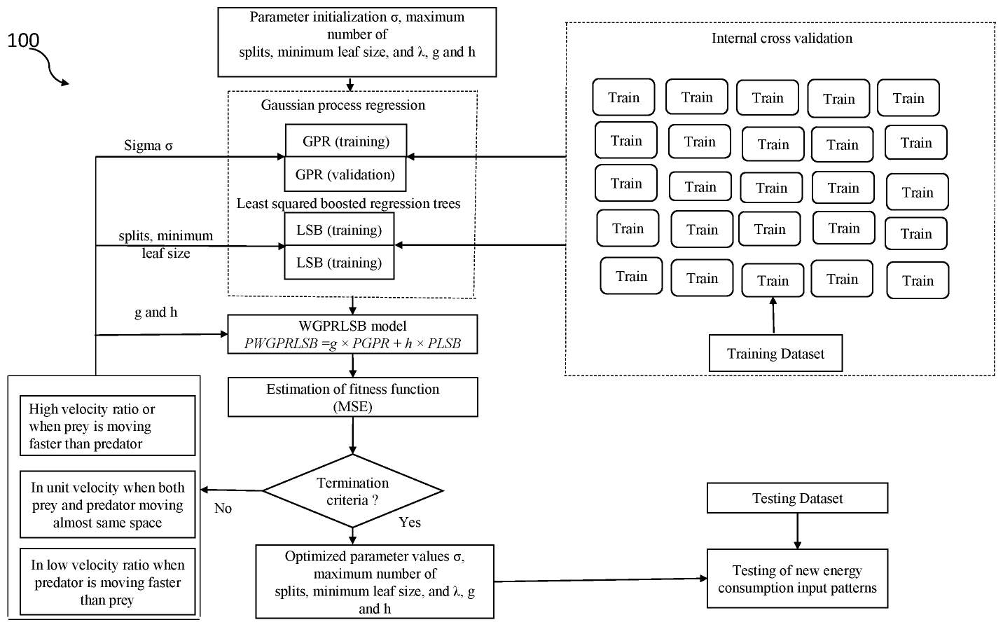

### FIELD

The present invention relates to a field of energy management system and more particularly a method using weighted aggregated ensemble model for energy demand management of buildings.

### BACKGROUND

The use of well-designed structures can improve total energy management in buildings, which is advantageous for sustainable building projects. These loads can be handled efficiently and effectively by the heating, ventilation, and air conditioning (HVAC) system. The machine learning techniques utilized in conventional methods, used singular forecasting models that are incapable of obtaining high precision. Each ML technique has advantages and disadvantages of its own. The prediction performance of a deep neural network is significantly impacted by the conventional ML approach, which is a time-consuming and challenging operation This problem is being addressed by researchers through the use of ensemble models. Ensemble learning is a machine learning framework in which the predictions of two or more techniques are combined. Ensemble elements, or approaches, can be identical or dissimilar, and they can be learned using the same or different training data. However, no generic predictive model based on ML approaches exists that can be used in all instances. As a result, model development is critical and must be done on an individual basis.

Therefore, there remains a need in the art for a method using weighted aggregated ensemble model for energy demand management of buildings that does not suffer from the above-mentioned deficiencies or at least provides a viable and effective solution.

### SUMMARY

The following presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

The present invention is generally directed to a method using weighted aggregated ensemble model for energy demand management of buildings. The aim of this method is to enhance HVAC unit functionality while lowering energy utilization. The performance of method has been evaluated by using MPO-inspired ensemble predictive model designed as a weighted linear aggregation of GPR and LSB (WGPRLSB) for the prediction of HL and CL, respectively. It can be concluded that the while comparing this method with other models, the projected values closely track the HL testing values for the proposed ensemble model. The results show that an ensemble model significantly improves system performance in comparison to other predictive models.

Some of the objects of the present disclosure, which at least one embodiment herein satisfies, are as follows.

It is an object of the present disclosure to ameliorate one or more problems of the prior art or to at least provide a useful alternative

An object of the present disclosure is to provide method using weighted aggregated ensemble model for energy demand management of buildings.

An object of the present disclosure is to provide a method using weighted aggregated ensemble model for energy demand management of buildings that can measures energy consumption with less error.

Another object of the present disclosure is to provide a method using weighted aggregated ensemble model for energy demand management of buildings that helps to improves system performance in comparison to other predictive models.

Still another object of the present disclosure is to provide a method using weighted aggregated ensemble model for energy demand management of buildings that is more reliable in terms of accuracy for predicting HVAC energy consumption.

Another object of the present disclosure is to provide a method using weighted aggregated ensemble model for energy demand management of buildings that results in excellent energy savings of buildings.

Other objects and advantages of the present disclosure will be more apparent from the following description, which is not intended to limit the scope of the present disclosure.

### BRIEF DESCRIPTION OF THE DRAWINGS

The Figure illustrates the method using weighted aggregated ensemble model for energy demand management of buildings, in accordance with an embodiment of the present invention.

### DETAILED DESCRIPTION

The following description is of exemplary embodiments only and is not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention.

While the present invention is described herein by way of example using embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes.

The Figure illustrates the method using weighted aggregated ensemble model for energy demand management of buildings, in accordance with an embodiment of the present invention. The method 100 comprises of initializing data values for integrated model to measure energy consumption, perform statistical analysis on data values to estimate accurate prediction, optimizing the data values using marine predator optimization for integrated model, analyze the output to minimize the mean square error and results show improvement in accuracy of integrated model. The data values comprise of σ, maximum number of splits, minimum leaf size, and λ. The weighted aggregated ensemble model for energy demand management of buildings shows best performance compared with other predictive models such as linear regression (LR), support vector, regression (SVR), multilayer perceptron neural network (MLPNN), decision tree (DT), and generalized additive model (GAM).

Description of Dataset

This section gives a detailed explanation of the database that is considered in this study. It consists of 8 input variables (M1, M2, M3, M4, M5, M6, M7, and M8) and

2 output variables (Z1, and Z2), respectively. Moreover, all of the houses vary in size and have three glazing regions, giving a total of five different distribution options. By combining 3 glazing regions, 5 distribution possibilities, and 12 building layouts, 720 housing modules with 4 viewpoints were constructed. In addition to the 720 housing structures, 12 building types without glazing regions were explored in 4 quadrants, which resulted in 768 housing modules. The 768 housing modules also had their own design, which was based on eight architectural design principles

Methodology

GPR is a nonparametric probability-based system that relies on kernels. The primary goal of GPR is to use available data to find a significant association among input and output variables. The main objective is to build a function that meets the requirements of Zi=h(Mi)+βi, where Zi and Mi are the output and input variables. Whereas, βi is the normally distributed additive noise [35]. The Gaussian process (GP) is characterized as a fixed bundle of unbounded variables with Gaussian distributions. It is mathematically defined by its mean p (M) and covariance g (M, M′) functions.

h(M)^{\tilde{ }}GP(M)(ρ(M),G(M,M′)). (1)

The mean and kernel functions can be given by equations (2) and (3)

ρ(M)=E[h(M)] (2)

g(M,M′)=E[(g(M)−ρ(M))(g(M′)−ρ(M′))] (3)

For GP, various kinds of kernel functions are accessible. Every function has its own set of properties and characteristics that can be used to fit models. Moreover, choosing a suitable kernel function for the data is among the most important issues in model development. The kernel function g (M, M′) is commonly defined in terms of hyper parameters. Kernel parameters are determined by the standard deviation σk and the scale of feature length σm.

Least Squared Boosted Regression Trees

LSB is a tree-based approach that creates a rigorous regression model using a gradient boosting approach. LSB output is a combination of forecasts from different models (1). These are created in a sequential manner, with each model being trained to fulfill the remainder error ^{{tilde over (()}}Zy) after assimilating the outcomes of all previous

Models.

The steps for implementing the algorithm are as follows.
a) y=0, established the forecastable output q0 (M)
b) Increase the value of y=1, and estimate the error using equation (4)

\tilde{Z}ⱼ^{y}=Zⱼ−q^{y-1}(Mⱼ) where,

j=1, 2, 3, . . . N (4)

c) Models 1 and error are fit together using least square objective function. Whereas, forecaster for inputs Mj is given by equation (5)

$$( {λ}_{y} , {a}_{y} ) = {argmin}_{a , λ} {\sum }_{j = 1}^{N} {[ {\tilde{Z}}_{j}^{y} - λ l ( {M}_{j} ; a ) ]}^{2} \qquad ( 5 )$$

where, a is belongs to the parameters of 1 and λ is the learning rate lies between 0 to 1.

d) Update

q^{y}(M)=q^{y-1}(M)+λ_{y}I(Mⱼα_{y}) (6)

e) Reiteration the steps (b) to (d), till y=Y for the maximum number of models.

where, Z is the output variable, qy(M) is the predicted output, Mj are the input variables, and N is total number of training samples respectively.

Marine Predator Optimization

MPO is a population-based optimization strategy that employs levy flight and Brownian mobility to capture prey in locations with a low or abundant prey population. Marine predators demonstrated the same amounts of levy and Brownian movements while exploring diverse environments over the course of their lives. They change their migration in an attempt to find regions with a diverse population of prey as a result of environmental influences such as eddy formation and human-caused (Fish Aggregating Devices (FADs)). In the 1st trial the preliminary solution

is dispersed homogeneously over the search region as follows

x₀=xₘᵢₙ+ [symbol] (xₘₐₓ [symbol] xₘᵢₙ) (7)

where xₘᵢₙ and xₘₐₓ are the lower and upper bounds for variables, and rand is the random vector, which has values between 0 and 1. According to the “survival of the fittest” hypothesis, apex predators are better at hunting. As a result, the best solution is to be designated as an apex predator in order to form a matrix known as Elite. This matrix's arrays are in charge of looking for and locating prey depending on the knowledge about the prey's location.

$$Elite = {[ \begin{matrix}{x}_{1 , 1}^{j} & {x}_{1 , 2}^{j} & ⋯ & {x}_{1 , \text{?}}^{j} \\ {x}_{2 , 1}^{j} & {x}_{2 , 2}^{j} & ⋯ & {x}_{2 , \text{?}}^{j} \\ ⋮ & ⋮ & ⋮ & ⋮ \\ {x}_{u , 1}^{j} & {x}_{u , 1}^{j} & ⋯ & {x}_{\text{?} , \text{?}}^{j}\end{matrix} ]}_{\text{?} \times \text{?}} \qquad ( 8 )$$

$$\text{?} \text{indicates text missing or illegible when filed}$$

where, →x J is the apex predator vector that is reproduced u-fold to create the Elite matrix. The number of searching agents is u, whereas the dimensionality is c. It should be highlighted that predator and prey are considered as searching agents. Since the prey is hunting for its own sustenance at the same time as the predator is searching for its prey. After every iteration, Elite matrices are updated due to the apex predator being replaced by the better one. However, prey will also be updating their positions while searching for food like predators according to the matrix called “Prey”.

$$Prey = {[ \begin{matrix}{x}_{1 , 1} & {x}_{1 , 2} & ⋯ & {x}_{1 , \text{?}} \\ {x}_{2 , 1} & {x}_{2 , 2} & ⋯ & {x}_{2 , \text{?}} \\ ⋮ & ⋮ & ⋮ & ⋮ \\ {x}_{u , 1} & {x}_{u , 2} & ⋯ & {x}_{\text{?} , \text{?}}\end{matrix} ]}_{\text{?} \times \text{?}} \qquad ( 9 )$$

$$\text{?} \text{indicates text missing or illegible when filed}$$

Further, the procedure of optimization in MPO is split into 3 phases according to their velocity and simultaneously simulates the whole life span of both predator and prey as follows

High velocity ratio (v≥10): Prey velocity is higher than predator velocity. This phase is considered an exploration phase. Mathematically, it can be described as follows:

$$while iter < \frac{1}{3} max\_ iter \qquad ( 10 )$$

$$\vec{{stepsize}_{i}} = \vec{{R}_{B}} ⊗ ( \vec{{Elite}_{i}} - \vec{{R}_{B}} \vec{⊗ {Prey}_{i}} )$$

$$i = 1 , 2 , ……… , u$$

$$\vec{{Prey}_{i}} = \vec{{Prey}_{i}} + P• \vec{R} ⊗ \vec{{stepsize}_{i}}$$

where, ⊗=Entry wise product

RB=Random number vector represents Brownian motion

P=It's a constant equal to 0.5

2. Unit velocity ratio (v 1/4 1): This is the transitional phase of the optimization procedure from exploration to exploitation, respectively. Which means half the population is used for exploration and the remaining half is used for exploitation. Furthermore, prey is responsible for exploitation by moving in levy flight, whereas predators move in Brownian motion.

$$while \frac{1}{3} max\_ iter < iter < \frac{2}{3} max\_ iter$$

For the first half of the population

\vec{stepsizeᵢ}=R_{L}⊗(\vec{Eliteⱼ}−\vec{R_{L}}⊗\vec{Preyᵢ})i=1, 2, . . . , u/2

\vec{Preyᵢ}=\vec{Preyᵢ}+P.\vec{R}⊗\vec{stepsizeᵢ} (11)

For the second half of the population

\vec{stepsizeᵢ}=\vec{R_{B}}⊗(\vec{R_{B}}⊗\vec{Eliteᵢ}−\vec{Preyᵢ})i=u/2, . . . , u (12)

\vec{Preyᵢ}=\vec{Eliteᵢ}+P.CF⊗\vec{stepsizeᵢ}

where, RL Random number vector represents levy movement

[symbol]

⊗\vec{Elite ᵢ}

It simulates the predator's Brownian motion movement

3. Low velocity ratio (v 1/4 0.1): The velocity of a predator is higher than that of its prey. This phase is linked mostly to the exploitation phase. The predators attain the levy movement with v=0.1. It can be modeled as

$$while \qquad ( 13 )$$

$$iter > \frac{2}{3} max\_ iter$$

$$\vec{{stepsize}_{i}} = \vec{{R}_{L}} ⊗ ( \vec{{R}_{L}} ⊗ \vec{{Elite}_{i}} - \vec{{Prey}_{i}} )$$

$$i = 1 , 2 , ……… , u$$

\vec{Preyᵢ}=\vec{Eliteᵢ}+P.CF⊗\vec{stepsizeᵢ}

where, \vec{R_{L}}⊗\vec{Eliteᵢ}

simulates the predator's levy flight movement.

4. The next point which is taken into consideration is the FAD effects. Which is mathematically described as follows

where, FADs=Probability of FADS effect equal to 0.2. I=Binary vector

r=Random no. [0,1]

r1 and r2=Random indexes of prey matrices

$$\vec{{Prey}_{i}} = \{ \begin{matrix}\vec{{Prey}_{i}} + CF [ \vec{{x}_{min}} + \vec{R} ⊗ {\vec{x}}_{max} - {\vec{x}}_{min} ) ] ⊗ \vec{I} & if r \leq FADs \\ \vec{{Prey}_{i}} + [ FADs ( 1 - r ) + r ] ( \vec{{Prey}_{rl}} - \vec{{Prey}_{rl}} ) & if r > FADs\end{matrix} \qquad ( 14 )$$

According to the highlighted elements, marine predators exhibit a strong retention for remembering where they've been effective in hunting. Memory management in MPA simulates this ability. After considering the effect of FDAs and updating the Prey matrix, fitness function is estimated in order to update the Elite matrix accordingly.

In the next steps, GPR and LSB are trained and cross validated. using the initialized values of the parameters, σ, maximum number of splits, minimum leaf size, and λ, respectively. The WGPRLSB model made the prediction (PWGPRLSB) by ensemble the individual predictions of GPR (PGPR) and LSB (PLSB). Each of the individual predictions is multiplied by their respective ensemble weight constants g and h in order to get the final ensemble prediction as follows:

P_{WGPRLSB}=g×P_{GPR}+h×P_{LSB} (15)

In the next step, the objective function will be estimated in order to evaluate the prediction accuracy of the proposed model. Mean squared error (MSE) is considered as an objective function which is optimized by MPO. MSE denotes the validation error obtained after 5 cross fold predictions. By comparing the objective function values after the completion of every loop, MPO will automatically search for the optimal values of all the parameters for WGPRLSB. The lower value of the objective function means the optimal value of the parameters (σ, maximum

number of splits, minimum leaf size, λ, g and h). The optimization algorithm

will stop when the current iteration is equal to the maximum number of iterations. When the stopping criteria are met, the loop is terminated, and we obtain the final optimal values of σ, maximum number of splits, minimum leaf size, λ, g and h, respectively. Finally, the performance of the WGPRLSB is tested against the optimized parametric values on a testing dataset.

Further the prediction accuracy of the proposed models will be evaluated on the basis of different performance criteria like, mean absolute error (MAE), root mean square error (RMSE), mean square error (MSE) and R-squared (R2) respectively.

$$RMSE = \sqrt{\frac{1}{N} {\sum }_{i = 1}^{N} {( {\hat{Z}}_{k} - {Z}_{k} )}^{2}} \qquad ( 16 )$$

$$MSE = \frac{1}{N} {\sum }_{i = 1}^{N} {( {\hat{Z}}_{k} - {Z}_{k} )}^{2} \qquad ( 17 )$$

$$MAE = \frac{1}{N} {\sum }_{i = 1}^{N} \vert {\hat{Z}}_{k} - {Z}_{k} \vert \qquad ( 18 )$$

$${R}^{2} = 1 - \frac{{\sum }_{i = 1}^{N} {( {\hat{Z}}_{k} - {Z}_{k} )}^{2}}{{\sum }_{i = 1}^{N} {( {Z}_{k} - {Z}_{mean} )}^{2}} \qquad ( 19 )$$

where [symbol] k and Zk are predicted and actual values under the kth independent variable, N is the total number of samples in the data set. While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

1. A method using weighted aggregated ensemble model for energy demand management of buildings, comprising:
a. initializing data values of integrated model for measurement of energy consumption of building;
b. performing statistical analysis on data values to estimate accurate prediction of energy demand management of buildings;
c. optimizing the data values using marine predator optimization for integrated model;
d. analyzing the optimized data values for energy demand management of buildings; and
e. generating conclusion that include information data that show improvement in accuracy of integrated model and accurately forecasts building energy demands.

2. The method as claimed in claim 1, wherein the data values includes σ, maximum number of splits, minimum leaf size, and λ.

3. The method as claimed in claim 1, wherein the statistical analysis on data values is performed by training and cross validating of integrated model.

4. The method as claimed in claim 1, wherein the integrated model includes gaussian process regression and least squared boosted regression trees.

5. The method as claimed in claim 1, wherein the optimizing the data values has been done by using marine predator optimization having lower and upper bounds.

6. The method as claimed in claim 1, wherein the weighted aggregated ensemble model for energy demand management of buildings shows best performance compared with other predictive models such as linear regression, support vector regression, multilayer perceptron neural network, decision tree, and generalized additive model.
